(19) United States
(12) Patent Application Publication
(10) Pub. No.: US 2026/0004332 A1
(43) Pub. Date: Jan. 1, 2026

(54) COMPETITIVE PRODUCT MATCHING LEVERAGING GENERATIVE ARTIFICIAL INTELLIGENCE

(71) Applicant: Rockwell Automation Technologies, Inc., Mayfield Heights, OH (US)

(72) Inventors: Brian C. Frank, Cedarburg, WI (US); Gerald W. Renderman, West Bend, WI (US); John P. Mason, Sussex, WI (US); Matthew S. Hill, Kitchener (CA); Chao G. Moua, Mequon, WI (US)

(21) Appl. No.: 18/754,729

(22) Filed: Jun. 26, 2024

(51) Int. Cl. G06Q 30/0601; G06Q 10/20

(52) U.S. Cl. CPC G06Q 30/0631; G06Q 10/20

(57) ABSTRACT

The disclosure describes a product matching application leveraging a General Artificial Intelligence (GAI) model to perform industrial product substitution recommendations. The product matching application may generate prompts for the GAI model, where the prompts include a first part number for an industrial product from a first manufacturer, with a request to respond with a part number of an industrial product from a second manufacturer that is an acceptable substitute for the first part number. The product matching application receives substitution recommendations from the GAI model and provides them to customers, according to some embodiments.

### TECHNICAL FIELD

The disclosure relates generally to competitive product matching systems and more specifically to leveraging a Generative Artificial Intelligence (GAI) model to perform competitive product matching for industrial automation products.

### BACKGROUND

When an industrial system needs to be replaced (e.g., the system has reached the end of its lifecycle) or cloned (e.g., where a factory design includes duplicates of the same industrial system), an operator may purchase a new line-up of industrial components to build a system performing the same function as the original system. For example, when a conveyor belt system approaches the end of its lifecycle, the operator may purchase new motors, belts, sensors, rollers, bearings, and the like, to build a new conveyor system. The operator may choose to build the new system with the same models of components that were included in the original system. However, the operator may sometimes wish to build the new system with components from a different manufacturer (for example, due to quality concerns, cost saving concerns or contractual considerations). Additionally, when an individual component such as a pump reaches the end of its lifecycle, the operator may wish to replace it with a new component manufactured by a different manufacturer.

When the operator wishes to switch to a new manufacturer, the new manufacturer may recommend in-house components for replacing the components of the previous system. Before the new manufacturer makes a recommendation, an engineer may perform an analysis to determine which components in the manufacturer's catalog are acceptable substitutes for the previously utilized components. This is a time-intensive process as it may include searching product catalogs, reviewing testing data, and reading specifications to compare functional capabilities and compatibility features. Due to the vast number of products in product catalogs of various manufacturers, it is infeasible for engineers to perform this analysis in advance (i.e., before a customer requests a product substitute) for all competitor products. As such, there may be delays in providing substitute recommendations to customers upon receiving requests to identify product substitutes. Such delays may result in losing sales or decreased customer satisfaction. Existing systems do not provide instantaneous product matching recommendations for all competitor products.

### SUMMARY

The disclosure describes a product matching application leveraging a General Artificial Intelligence (GAI) model to generate product substitution recommendations. The product matching application generates prompts requesting product match recommendations and submits the prompts to the GAI model. The product matching application may also maintain a database of matches including model-generated matches, engineer-approved matches, and community-approved matches.

A computer-implemented method for competitive product matching performed according to some embodiments includes identifying a first product number of a first industrial product manufactured by a first manufacturer. The method further includes determining to utilize a General Artificial Intelligence (GAI) model to identify an equivalent industrial product manufactured by a second manufacturer, where the GAI model is trained on industrial product information. The method further includes generating a prompt for the GAI model. The prompt includes the first product number and a request to provide a second product number of a second industrial product manufactured by the second manufacturer and capable of substitution for the first industrial product. The method further includes submitting the prompt to the GAI model. The method further includes receiving, from the GAI model in response to the prompt, a response including the second product number of the second industrial product manufactured by the second manufacturer. The method further includes storing the first product number in association with the second product number in a database and indicating a model-generated match.

In some embodiments, determining to utilize the GAI model include determining that there are no engineer-approved product matches for the first industrial product and determining that there are no community-approved matches for the second industrial product.

In some embodiments the identifying the first product number includes receiving, via a user interface, a query. The query includes the first product number, and a request to identify a corresponding industrial product manufactured by the second manufacturer. The method further includes providing, via the user interface, a notification including the second product number.

In some embodiments, the notification provided to the user further includes an indication that the second industrial product was generated by the GAI model. The notification further includes a user prompt requesting approval to use the second industrial product as an acceptable substitute for the first industrial product. The method further includes receiving, from the user, an indication that the second industrial product is an acceptable substitute for the first industrial product. The method further includes in response to receiving the indication from the user, storing the first product number in association with the second product number as a community-approved match.

In some embodiments, the method further includes providing, to an engineer, a request for approval to use the second industrial product as an acceptable substitute for the first industrial product. In some embodiments, providing the request for approval for to the engineer may be in response to receiving community approval (i.e., in response to receiving the indication from the user that the second industrial product is an acceptable substitute for the first industrial product as described above). The method further includes receiving, from the engineer, an indication that the second industrial product is an acceptable substitute for the first industrial product. The method further includes, in response to receiving the indication from the engineer, storing the first product number in association with the second product number as an engineer-approved match.

In some embodiments, the method further includes training the GAI model with the industrial product information comprising one or more of: industrial product specifications, industrial product certifications, industrial product regulations, industrial product catalogs, or a combination thereof.

In some embodiments, the first product number is one of a plurality of product numbers for industrial products manufactured by the first manufacturer. In some embodiments, the determining that assistance from the GAI model is required comprises determining that assistance from the GAI model is required to perform a product matching function for a subset of the plurality of product numbers, the subset including the first product number. In some embodiments, the prompt further includes each product number of the subset of product numbers. In some embodiments, the response from the GAI model further includes a second plurality of product numbers including the second product number, each of the second plurality of product numbers being provided as substitution recommendations for a corresponding product number from the subset of product numbers.

In some embodiments, the prompt further includes an instruction to search for specifications for the first industrial product from the first manufacturer. In some embodiments, the request to provide the second product number in the prompt includes a request to determine the second product number based on the specifications for the first industrial product.

In some embodiments, the prompt further includes a request to generate a confidence score indicating a likelihood that the second industrial product is an acceptable substitute for the first industrial product. In some embodiments, the response further includes the confidence score.

These and other features and aspects of various examples may be understood in view of the following detailed discussion and accompanying drawings.

### BRIEF DESCRIPTION OF THE DRAWINGS

FIG. 1 illustrates a product matching system, according to some embodiments.

FIG. 2 illustrates the cloud platform of FIG. 1, according to some embodiments.

FIG. 3 illustrates a decision tree executed according to some embodiments.

FIGS. 4A and 4B illustrate a method performed according to some embodiments.

FIG. 5 illustrates an operational scenario for the product matching system of FIG. 1, according to some embodiments.

FIG. 6 illustrates a user interface, according to some embodiments.

FIG. 7 illustrates a prompt template, according to some embodiments.

FIG. 8 illustrates a computing system, according to some embodiments.

### DETAILED DESCRIPTION

In factory environments, operators may often duplicate existing industrial systems. For example, at the end of an industrial system's lifecycle, an operator uninstalls and replaces the system with a duplicate of the system. In another example, a new design for a factory may include clones of the existing industrial system (to avoid designing new industrial systems from scratch). When duplicating existing industrial systems, the operator may choose to replace the industrial system using components made by the same manufacturer as the original system. In such cases, the operator may simply purchase the same component models that were included in the original system. However, operators may choose to switch to a different manufacturer. This decision may be based on a variety of reasons including cost saving concerns, quality concerns, and contractual considerations. As an example, a conveyor belt system on a factory floor may be composed of components made by a first manufacturer. Towards the end of the lifecycle of the conveyor belt system, an operator may choose to replace the conveyor belt system using products made by a second manufacturer (e.g., Rockwell Automation) instead of the first manufacturer. To facilitate the transition, the second manufacturer may provide operators with in-house products (i.e., products made by the second manufacturer) that are close equivalents to the products included in the original system being replaced. The second manufacturer may utilize engineers to determine which in-house products are close equivalents to various competitor products. However, this is a complex and time-intensive process, engineers must consider various factors including functional capabilities, interoperability, lifecycle, durability, and cost, among other factors. Since there are a vast number of industrial products sold by various manufacturers, it is infeasible for engineers to perform a matching analysis for all competitor products before a user submits a matching request. As such, there are delays in providing substitution recommendations in existing systems. Delays may result in the loss of sales and decreased customer satisfaction.

The present disclosure describes a product matching application leveraging a General Artificial Intelligence (GAI) model to determine acceptable product substitutes between different manufacturers. The product matching application crafts prompts for the GAI model, where the prompts may include a list of first product numbers (e.g., product numbers for industrial products made by the first manufacturer/competitor) and a request to identify close equivalent products made by the second manufacturer. The product matching application may generate the prompt in response to the receiving a product matching query from a user (e.g., an operator replacing an industrial system). The GAI model is trained on industrial product information (e.g., specifications, models, and certifications) to identify close equivalent products made by different manufacturers. The model-generated product equivalents may be provided to the customers as recommendations, and/or may be added to a match database for future requests. As such, the product matching application quickly provides recommendations to customers and maintains a robust database of product matches.

The product matching application described herein greatly increases speed and efficiency in providing substitution recommendations to customers. Specifically, when a customer submits a request for substitution of a list of products made by a first manufacturer, the customer may almost instantaneously receive a list of equivalent products made by the second manufacturer. In previous systems, it may have taken weeks for industrial manufacturers to respond to substitution requests due to backlogs and the complex engineer analysis required. In the system disclosed herein, however, the customer may instantaneously receive equivalent product recommendations. This enhances the customer experience and makes the process of transitioning to a different manufacturer easier. Furthermore, resource usage may be optimized in the disclosed system, since matches may be stored in a database using product numbers, without the need to download and store a vast number of specifications for competitor products. The disclosed system may also operate at a much greater scale than existing systems. Specifically, while existing systems only include approved matches for a relatively small percentage of competitor products, the product matching application of the present disclosure may include or quickly generate substitution recommendations for almost all competitor products.

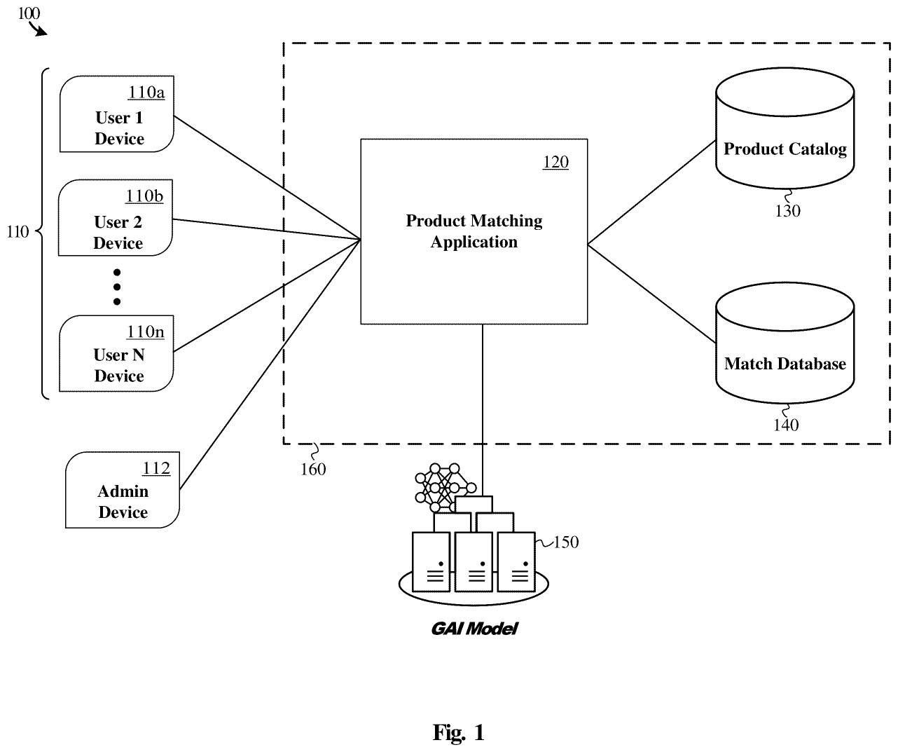

FIG. 1 illustrates system 100 according to some embodiments. System 100 includes user devices 110, admin device 112, cloud platform 160, and GAI model 150. While specific elements of system 100 are shown for ease of description, system 100 may include more or fewer of each described component as well as other components not described for simplicity.

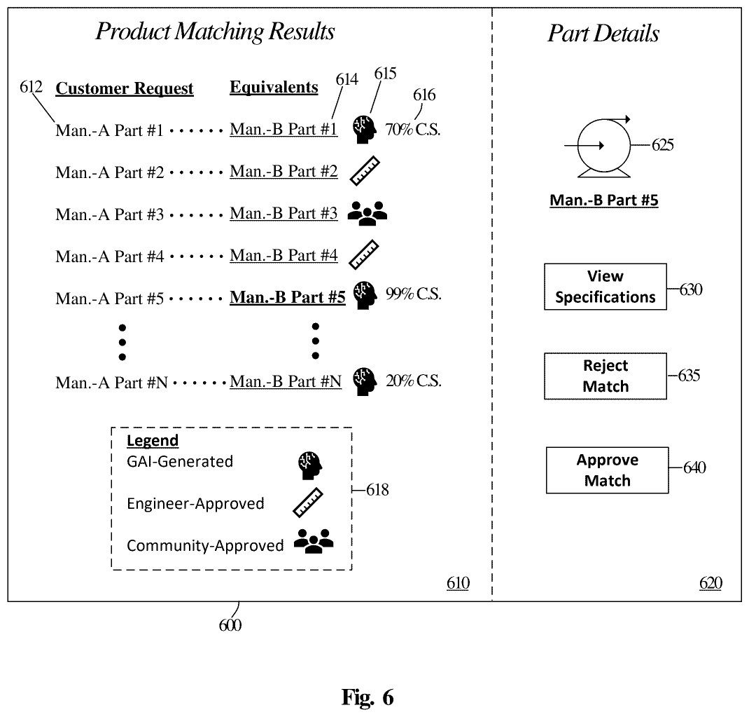

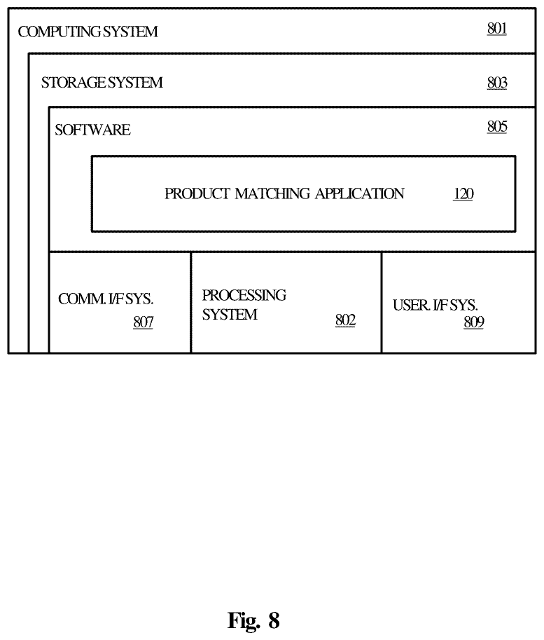

User devices 110 include user 1 device 110a, user 2 device 110b, and user N device 110n. While three user devices are shown in FIG. 1 for simplicity, system 100 may include any number N of user devices 110. User devices 110 may include personal computers, laptops, mobile devices such as smartphones or tablets, or any other similar device capable of interfacing with product matching application 120. Users may access product matching application 120 on user devices 110. Specifically, users may log into a user account on a web browser on the user device to access product matching application 120. In some embodiments, the users may open an application program on user device 110 to access product matching application 120. In either case, product matching application 120 provides a user interface to display to the user on user device 110 (for example, user display 600 of FIG. 6). User devices 110 may be computing device 801 as described in relation to FIG. 8.

Users access product matching application 120 via user interfaces on user devices 110. The user may submit, via the user interface, a product matching query including a list of products from a first manufacturer (e.g., a competitor) with a request for equivalent products manufactured by a second manufacturer (e.g., the owner of the product matching application 120). The user may receive a notification responding to the query via the user interface, such as user display 600 of FIG. 6 discussed in further detail below.

Admin device 112 is used by administrators to perform administrative tasks in product matching application 120. While one admin device 112 is shown in FIG. 1 for simplicity, the system may include multiple admin devices 112 utilized by multiple administrators of product matching application 120. Admin devices 112 may include personal computers, laptops, mobile devices such as smartphones or tablets, or any other similar device. Administrators (for example, industrial design engineers) may access product matching application 120 via user interfaces on admin devices 112. The administrators may perform various tasks via the user interfaces; for example, reviewing model-generated matches (as described in step 421 in method 400), updating software of product matching application 120, and maintaining match database 140. The user interfaces may be viewed, for example, in web browsers or application programs. Admin devices 112 may be computing device 801.

Cloud platform 160 includes product matching application 120, product catalog 130, match database 140, and Generative Artificial Intelligence (GAI) model 150. Cloud platform 160 operates from servers which may be in data centers, distributed in various geographic locations, and the like. Various software components of the cloud platform may have multiple instances in different geographic locations for redundancy and speed.

Product matching application 120 includes software operating from servers in cloud platform 160. Product matching application 120 may be included in a web-based application for assisting users in the purchase of industrial products. Users may use product matching application 120 to view industrial product catalogs, view industrial product specifications, and make requests for identification of equivalent products. Product matching application 120 may be implemented in memory on a server such as, for example, computing device 801 as described with respect to FIG. 8.

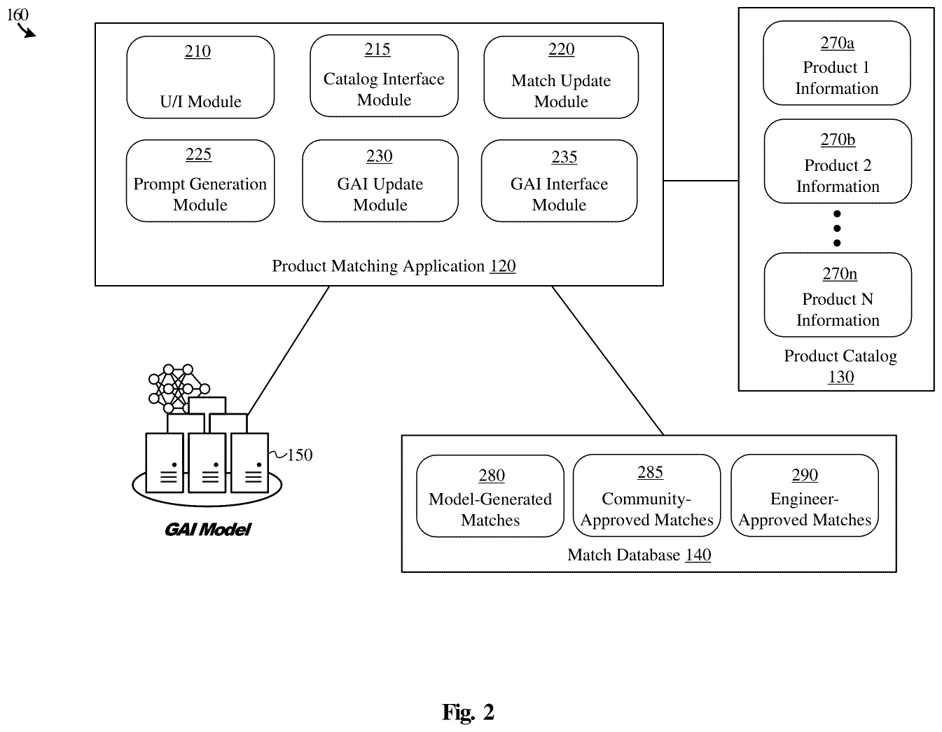

Product matching application 120 may receive product matching queries from customers (i.e., users on user devices 110). Users may submit the product matching queries from user devices 110 using a range of different platforms (e.g., standalone applications, online software platforms, chatbots, APIs, etc.) in various embodiments. A product matching query may include a first part number for a first industrial product manufactured by a first manufacturer (e.g., a competitor) with a request to provide a second product number of a second industrial product manufactured by a second manufacturer (e.g., the owner of product matching application 120) and that is the closest equivalent product capable of substitution for the first industrial product. A product matching query may also include a list of product numbers for products made by the first manufacturer with a request to identify equivalent products manufactured by the second manufacturer for all of the product numbers in the list. Such a list of products may represent a line-up of components included in an industrial system (e.g., pumps, valves, sensors, etc. included in a mixing system). While the second manufacturer is here described as the owner of product matching application 120, in some embodiments the second manufacturer may be a different entity. As such, the product matching application may be utilized to perform competitive-product matching functions for various unrelated manufacturers (e.g., when product matching application 120 is provided to various third-party manufacturers as a software service). Furthermore, FIG. 2 includes additional details of the functionalities performed by product matching application 120.

Product catalog 130 is a database containing information about products sold by the owner of product matching application 120. The information in the product catalog may be stored in memory of cloud platform 160. The information about each product may include part numbers, product specifications, regulatory certifications, capabilities, and other product literature. The information stored in the product catalog, including part numbers and specifications, may be provided to GAI model 150 to train the GAI model 150 to identify close equivalent industrial products. Furthermore, FIG. 2 contains additional details about product catalog 130. Information in product catalog 130 may be stored in servers or other memory storage devices of cloud platform 160.

Match database 140 is a database containing information about which products manufactured by the second manufacturer (e.g., the owner of product matching application 120) are the closest equivalents to products manufactured by other manufacturers (including the “first manufacturer”). It is noted that close equivalent products are also referred to as “matches” or “product matches.” Each product match may include a part number for a product made by a first manufacturer (e.g., a competitor manufacturer) stored in association with a part number for a product made by a second manufacturer (e.g., the owner of product matching application 120). In addition, each product match may include an indication of whether the match is an engineer-approved match, a community-approved match, or a model-generated match, as discussed in further detail in FIG. 2 below. Information in match database 140 may be stored in servers or other memory storage devices of cloud platform 160.

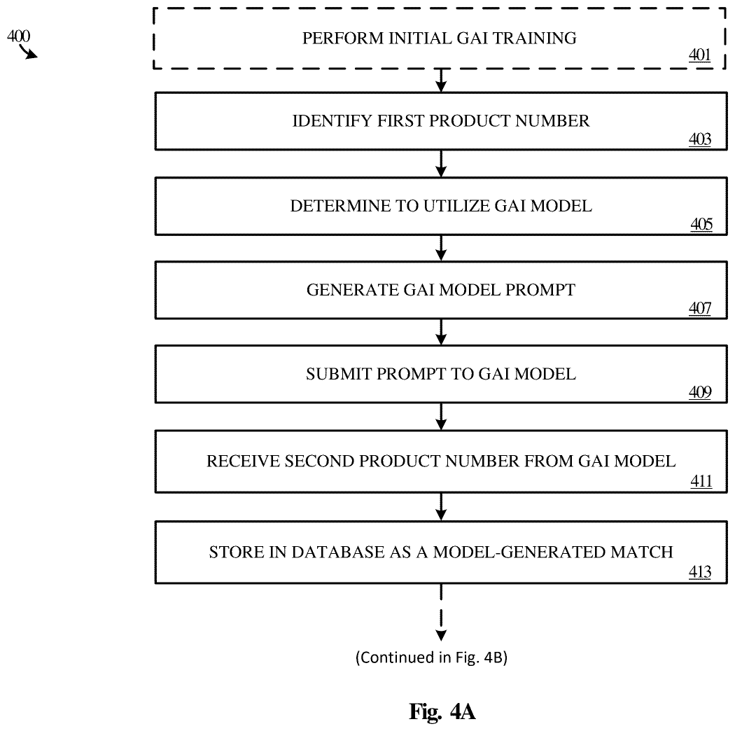

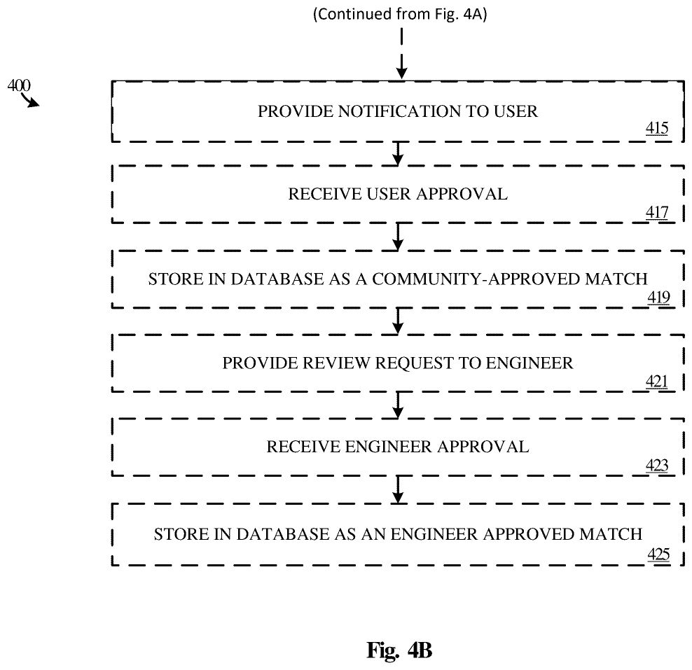

GAI model 150 is a generative artificial intelligence model trained to perform competitive product matching functions. GAI model 150 may include a system of transformer-based neural networks with a vast number of parameters (e.g., weights and balances). The parameters are adjusted during training for learning including industrial data and common selections among users of product matching application 120. The training of GAI model 150 is discussed in further detail in method 400 below. GAI model 150 may be a large language model (LLM) trained on a vast amount of textual data. An LLM is capable of processing textual inputs to generate textual outputs. In some embodiments, GAI model 150 is a Multi-Modal Model (MMM). An MMM may be trained on a vast amount of various types of data, including, for example, textual data, video, audio, images, 3-D renderings, CAD files, and other various forms of media. An MMM may be capable of processing inputs and generating outputs in each of these formats. Product matching application 120 leverages GAI model 150 to provide industrial product substitution recommendations, as discussed in greater detail in method 400 of FIGS. 4A and 4B. Further, GAI model 150 is depicted outside of cloud platform 160. However, in some embodiments, GAI model 150 may be hosted within cloud platform 160, for example, as an enterprise-specific instance.

GAI models (also known as foundation models) are models trained to generate new data based on a training dataset. GAI models as used herein include large-scale generative artificial intelligence (AI) models trained on massive quantities of diverse, unlabeled data. The GAI models learn using self-supervised, semi-supervised, or unsupervised techniques. GAI models perform many downstream tasks based on capturing general knowledge, semantic representations, and patterns and regularities in the training data. In some embodiments, such as embodiments included herein, a GAI model may be fine-tuned for specific downstream tasks. GAI models include BERT (Bidirectional Encoder Representations from Transformers) and ResNet (Residual Neural Network). GAI models may be based on any relevant architecture, including, for example, generative adversarial networks (GANs), variational auto-encoders (VAEs), and transformer models, including multimodal transformer models. Depending on the type of input accepted and output provided, GAI models may be multimodal or unimodal.

Multimodal models are a class of GAI models that accept multimodal data including text, image, video, and audio data. Multimodal models may leverage techniques like attention mechanisms and shared encoders to fuse information from different modalities and create joint representations. Learning joint representations across different modalities enables multimodal models to generate multimodal outputs that are coherent, diverse, expressive, and contextually rich. For example, multimodal models can generate a caption or textual description of a given image by extracting visual features using an image encoder, then feeding the visual features to a language decoder to generate a descriptive caption. Similarly, multimodal models can generate an image based on a text description (or, in some scenarios, a spoken description transcribed by a speech-to-text engine). Multimodal models work in a similar fashion with video-generating a text description of the video or generating video based on a text description. GAI model 150 may be implemented on a computing device (e.g., computing device 801 of FIG. 8), typically in a cloud-based environment due to the processing and memory resources needed to support GAI model 150. However, on-premises implementations are within the scope of this disclosure.

Multimodal models include visual-language foundation models, such as CLIP (Contrastive Language-Image Pre-training), ALIGN (A Large-scale ImaGe and Noisy-text embedding), and VILBERT (Visual-and-Language BERT), for computer vision tasks. Examples of visual multimodal or foundation models include DALL-E, DALL-E 2, Flamingo, Florence, and NOOR. Types of multimodal models may be broadly classified as or include cross-modal models, multimodal fusion models, and audio-visual models, depending on the particular characteristics or usage of the model.

Large language models (LLMs) are a type of GAI model that process and generate natural language text. These models are trained on massive amounts of textual data. LLMs learn to generate relevant responses given a prompt or input text. The responses are coherent and contextually relevant to the given prompt. LLMs understand and generate sophisticated language based on their training. LLMs capture intricate patterns, semantics, and contextual dependencies in textual data. In some cases, LLMs may be used in multimodel models. For example, the LLM intelligence is used to combine images and audio input with textual input to generate multimodal output. Types of LLMs include language generation models, language understanding models, and transformer models.

Transformer models, including transformer-type foundation models and transformer-type LLMs, are a class of deep learning models used in natural language processing (NLP). Transformer models are based on a neural network architecture which uses self-attention mechanisms to process input data and capture contextual relationships between words in a sentence or text passage. Transformer models weigh the importance of different words in a sequence, allowing them to capture long-range dependencies and relationships between words. GPT (Generative Pre-trained Transformer) models, BERT (Bidirectional Encoder Representations from Transformer) models, ERNIE (Enhanced Representation through kNowledge Integration) models, T5 (Text-to-Text Transfer Transformer), and XLNet models are types of transformer models which have been pretrained on large amounts of text data using a self-supervised learning technique called masked language modeling. For example, large language models, such as ChatGPT and its brethren, have been pretrained on an immense amount of data across virtually every domain of the arts and sciences. This pretraining allows the models to learn a rich representation of language that can be fine-tuned for specific NLP tasks, such as text generation, language translation, or sentiment analysis. Moreover, these models have demonstrated emergent capabilities in generating responses that are creative, open-ended, and unpredictable.

FIG. 2 illustrates cloud platform 160 according to some embodiments. The cloud platform 160 includes product matching application 120, product catalog 130, match database 140, and GAI model 150. While specific elements of the cloud platform are shown for case of description, cloud platform 160 may include more or fewer of each described component as well as other components not described for simplicity. Note that GAI model 150 is depicted as part of cloud platform 160 in FIG. 2, however, this is an optional configuration as discussed above with respect to FIG. 1. GAI model 150 may be hosted within cloud platform 160 or externally without departing from the spirit and scope of this disclosure.

Product catalog 130 is a database of information about industrial products sold by a manufacturer, for example, the owner of product matching application 120. The product catalog may be computing device 801.

Product catalog 130 stores information about the products sold by the manufacture, including Product 1 Information 270a, Product 2 Information 270b, and Product N Information 270n (collectively, Product Information 270) for “N” number of products. The product catalog may include information related to a large number of products sold by the second manufacturer. For example, an industrial manufacturer such as Rockwell Automation may have on the order of thousands of products in the product catalog, including various models of pumps, valves, sensors, motor controllers, circuit breakers, and many other product types. Product information 270 included in product catalog 130 may include, for example, part numbers, product names, specifications, diagrams, CAD files, and other product literature. A user of product matching application 120 may view the some or all product information 270 in the product catalog 130 via a user interface of the user device 110 (of FIG. 1). The user may be a customer, for example, who wishes to purchase products for installation on a factory floor. As such, the user may browse the product information 270 in the product catalog 130 and select various components for purchase. Product matching application 120 may provide product information 270 to GAI model 150 to train GAI model 150 to identify equivalent products between different manufacturers.

Match database 140 is a database of product matches, where a product match is an indication that a product made by a first manufacturer (e.g., a competitor) can be substituted with a specific product made by a second manufacturer (e.g., the owner of the product matching application 120). Match database 140 includes model-generated matches 280, community-approved matches 285, and engineer-approved matches 290. Each match may be stored as a first product number of an industrial product made by a competitor manufacturer (e.g., the first manufacturer) with a second product number of an industrial product made by the second manufacturer. Each match may further include an indicator of whether the match is model-generated match 280, community-approved match 285, or engineer-approved match 290. Each match may also include various other metadata such as the names of the manufacturers. Match database 140 may be computing device 801.

Model-generated match 280 is a match generated by GAI model 150. A GAI model 150 may generate a match by responding to a prompt with a substitution recommendation (i.e., a second product number recommended as close equivalent of the first product number). Model-generated match 280 may be stored in match database 140 as a first product number (e.g., of a first industrial product made by the first manufacturer/competitor) stored in association with a second product number (e.g., of a second industrial product made by the second manufacturer/owner of product matching application 120). Model-generated match 280 may also be stored with a status indicator that the match was generated by GAI model 150. In some embodiments, model-generated matches may be stored in a separate library within match database 140 reserved for model-generated matches.

Community-approved match 285 is a match in which one or more users/customers have indicated that product manufactured by the second manufacturer (e.g., the owner of product matching application 120) is an acceptable substitute for a product manufactured by the first manufacturer (e.g., a competitor). In some examples, a user may approve a match by clicking button 640 in user display 600 of FIG. 6. A match may be designated as community-approved match 285 when a threshold number of users have approved the match. In some examples, the threshold number may be one, such that a match is designated community-approved match 285 when one user approves the match. In other embodiments, the threshold may be a higher number such as ten, one-hundred, or more, such that a match is not designated as community-approved unless multiple users approve the match. Community-approved match 285 may be stored in match database 140 as a first product number (e.g., of a first industrial product made by the first manufacturer/competitor) stored in association with a second product number (e.g., of a second industrial product made by the second manufacturer/owner of product matching application 120). Community-approved match 285 may also be stored with a status indicator that the match is community-approved. In some embodiments, model-generated matches may be stored in a separate library within match database 140 reserved for community-approved matches.

Engineer-approved match 290 is a match that has been reviewed and approved by an engineer. When reviewing a match, an engineer conducts an analysis to determine if a second industrial product is an acceptable substitute for a first industrial product. This analysis may include reviewing product literature to determine if the second industrial product can perform the same or close to the same functions as the first industrial product, if the second industrial product has similar interoperability features (e.g., electrical fittings and mounting features), if the physical dimensions of the industrial product are similar, and other considerations. After conducting the analysis, the engineer may submit approval of the match to the product matching application, for example, via a user interface of admin device 112. Engineer-approved match 290 may be stored in match database 140 as a first product number (e.g., of a first industrial product made by the first manufacturer/competitor) stored in association with a second product number (e.g., of a second industrial product made by the second manufacturer/owner of product matching application 120). Engineer-approved match 290 may also be stored with a status indicator that the match is community-approved. In some embodiments, model-generated matches may be stored in a separate library within match database 140 reserved for engineer-approved matches.

Product matching application 120 may be a web-based application utilized by customers to purchase industrial products and request equivalent product identifications. Product matching application 120 interfaces with product catalog 130, match database 140, GAI model 150, user devices 110 (see FIG. 1), and admin devices 112 (see FIG. 1). Product matching application 120 may be computing device 801 as described below in relation to FIG. 8.

Product matching application 120 includes User Interface (U/I) Module 210, Catalog Interface Module 215, Match Update Module 220, Prompt Generation Module 225, GAI Update Module 230, and GAI Interface Module 235. Further, while these modules are depicted to describe functionality for identifying competitive products from a manufacturer that match a product from a different manufacturer using product matching application 120, the functionalities described may be incorporated into more or fewer components, software components, hardware components, firmware components, or a combination thereof without departing from the scope and spirit of the present disclosure. Each of the modules is discussed in turn below.

U/I Module 210 interfaces with user devices 110 and admin devices 112 to render displays and receive inputs and requests. U/I Module 210 sends information for rendering a user display on the user devices. A user on user device 110 may submit product substitution requests via U/I Module 210, as discussed in step 403 of method 400 below. Once matches have been determined (as discussed in further detail in method 400), U/I Module 210 provides a notification with the substitution recommendation in the user display, as shown for example in user display 600 of FIG. 6.

Users on user devices 110 and administrators on admin devices 112 may perform various other tasks via U/I Module 210. For example, users may view product catalog 130 via U/I Module 210 (e.g., by adding information about new products to the product catalog, removing information about outdated industrial products, etc.). Furthermore, administrators may submit approvals of matches via U/I Module 210. Once U/I Module 210 receives an approval from an engineer, Match Update Module 220 adds the match to match database 140 as engineer-approved match 290, as discussed in further detail below.

Catalog Interface Module 215 interfaces with Product Catalog 130 to retrieve information from the Product Catalog 130 and to update Product Catalog 130. For example, when a user requests information about a product, the Catalog Interface Module 215 retrieves product information 270 from product catalog 130 to provide to the user via U/I Module 210. Additionally, an administrator may submit a request (via U/I Module 210) to update the Product Catalog 130 with new product information. Upon receipt of the request, Catalog Interface Module 215 may add the new product information to Product Catalog 130. The Catalog Interface Module 215 may retrieve product information 270 to provide to the GAI model 150 as training via GAI Update Module 230.

Match Update Module 220 maintains match database 140 by adding new matches to match database 140. When GAI model 150 provides a recommended industrial product substitution (i.e., a “match”) to Product Matching Application 120, Match Update Module 220 adds the match to match database 140 as a model-generated match. When a user approves a match (for example, by clicking button 640 in user display 600 of FIG. 6), Match Update Module 220 may add the match to the match database 140 as community-approved match 285. However, it is noted that in some embodiments, Match Update Module 220 only adds the match to match database 140 as community-approved match 285 when a threshold number of users (e.g., 5, 10, or 100) approve the match. When an engineer approves a match, Match Update Module 220 adds the match to match database 140 as engineer-approved match 290.

In some embodiments, Match Update Module 220 may also initiate periodic reviews of the matches in match database 140 (including model-generated matches 280, community-approved matches 285, and engineer-approved matches 290). Periodic reviews may be used to identify outdated matches in match database. A match may become outdated, for example, when the recommended product substitution has become obsolete or is no longer manufactured by the second manufacturer. A review may be initiated periodically for each match in match database 140 (e.g., monthly or yearly), or may be initiated on request from an administrator via admin device 112. Once a review for a match has been initiated by Match Update Module 220, Prompt Generation Module 225 generates a prompt for GAI model 150 including an identification of the match (including the associated product numbers) and a request for GAI model 150 to review the match. In some embodiments, the prompt may further include a request to generate a new match if the current match has become outdated. GAI Interface module 235 submits the prompt to GAI model 150 and receives a response from GAI model 150. The response includes the model's determination of whether or not the match has become outdated. If the response indicates that the match has become outdated, Match Update Module 220 removes the match from match database 140. It is noted that in some embodiments, administrator approval may be required before removing a match from match database 140. In some embodiments, a new match recommendation may be received in the response from GAI model 150 in the response, upon which Match Update Module 220 adds the new match recommendation to model-generated matches 280 of match database 140. If GAI model 150 indicates that the match has not become outdated, no further action is taken.

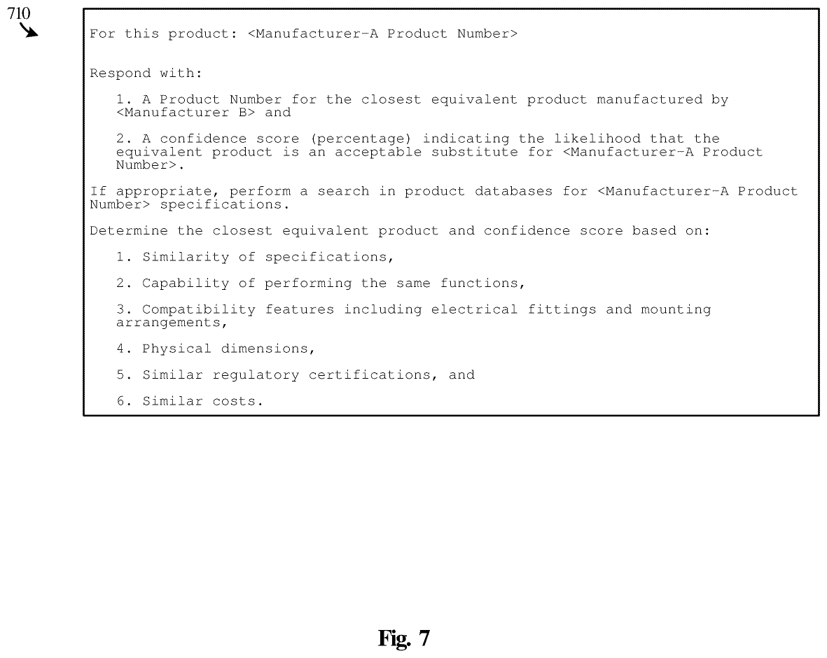

The Prompt Generation Module 225 generates prompts for the GAI model 150. The Prompt Generation Module 225 uses a prompt template, such as the prompt template 710 of FIG. 7, to generate the prompt. The prompt template 710 may include a combination of text and placeholders.

Prompt Generation Module 225 makes determinations to utilize GAI model 150 to identify equivalent industrial products. Determining to utilize the GAI model 150 may be based on determining, for a first industrial product made by first manufacturer (i.e., a competitor), that there is no engineer-approved match 290, community-approved match 285, or previously existing model-generated match 280. Once this determination is made, Prompt Generation Module 225 generates a prompt for GAI model 150.

A prompt generated by Prompt Generation Module 225 may include a first product number of a first industrial product manufactured by a first manufacturer (i.e., a competitor manufacturer) and a request to provide a second product number of a second industrial product manufactured by the second manufacturer (i.e., the owner of the product matching application 120) and that is the closest equivalent and capable of substitution for the first industrial product. While this is generally the included information in a prompt, the prompts are designed to elicit the desired information from GAI model 150, and may not initially generate appropriate results. Accordingly, modification of the prompts and prompt templates may improve results from GAI model 150. GAI model 150 is trained using product information for products from all manufacturers, but GAI model 150 will only return what is asked for in the prompt. Accordingly, the prompt design ensures that GAI model 150 returns relevant and accurate results based on the details included in the prompt.

GAI Update Module 230 continually provides new data to GAI model 150 to update GAI model 150 over time. The new data provided to GAI model 150 includes new product information, including part names, specifications, and other literature for newly released products. GAI Update Module 230 may provide the GAI model with product information associated both with products manufactured by the owner of the product matching application 120, and products manufactured by third-party manufacturers.

GAI Update Module 230 may also provide GAI model 150 with user feedback. User feedback may be received, for example, via user display 600 of FIG. 6. Specifically, users may approve the match by clicking button 640 or reject the match by clicking button 635. When U/I Module 210 receives such an approval or rejection, GAI Update Module 230 may provide the approval or rejection to GAI model 150 as feedback.

GAI Interface Module 235 interfaces with GAI model 150 to provide prompts to GAI model 150 and receive responses from GAI model 150. Once the Prompt Generation Module 225 generates a prompt as discussed above, GAI Interface Module 235 submits the prompts to GAI model 150. GAI Interface Module 235 also receives responses to the submitted prompts from GAI model 150. Upon receiving the responses to the prompts (e.g., recommended product matches), GAI Interface Module 235 may perform initial validation including checking for corrupted data, checking syntax, and checking validity (e.g., checking that the product number in the response is an actual product made by the manufacturer).

GAI model 150 is a large artificial intelligence model trained to perform industrial design tasks for product matching application 120. GAI model 150 may be an LLM or an MMM as discussed above. GAI model 150 may include multi-layered transformer architecture with many parameters (e.g., weights and biases) encoding information. GAI model 150 may be created by training a base model to perform competitive product-matching functions (as described in method 400). Such a base model may be licensed and hosted by a third party. Alternatively, the base model may be purchased or provided as an open-source model. Base models have generally been pre-trained on a vast amount of data. However, even though a base model may be pre-trained, it is generally not specifically trained to perform industrial design tasks. As such, initial training to perform competitive product matching may be performed to fine-tune the model to perform industrial design tasks. After the initial training, the model may be further trained to provide user-specific customizations. The training process for GAI model 150 is discussed in greater detail below. As discussed in greater detail in method 400 below, GAI model 150 receives prompts requesting product substitution recommendations and responds with recommended industrial product substitutions. GAI model 150 may be the computing device 801 as described below in relation to FIG. 8.

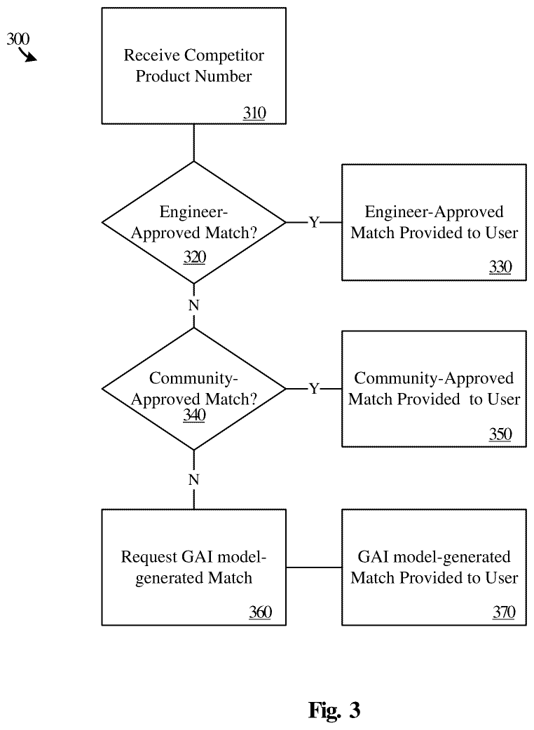

FIG. 3 illustrates decision tree 300 executed according to some embodiments of the present disclosure. The decision tree may be carried out by code embedded in product matching application 120. The decision tree may be executed, for example, by Prompt Generation Module 225 of FIG. 2.

Decision tree 300 begins with receiving a competitor product number at step 310. The product number may be received for example, in a product matching query submitted by a user (for example via a user interface on user device 110). The query may include a competitor product number of an industrial product from first manufacturer (e.g., a competitor) and a request to identify an equivalent industrial product manufactured by the second manufacturer (e.g., the owner of product matching application 120). It is noted that the product matching query may include a list of competitor product numbers. In such cases, decision tree 300 may be executed individually for each product name in the query. As such, a response to a product matching query may include a mix of model-generated matches, community-approved matches, and engineer-approved matches, as demonstrated in user display 600 of FIG. 6.

Step 320 of decision tree 300 is determining whether there is an engineer-approved match associated with the competitor product number in the query. Step 320 may include, for example, checking match database 140 to determine if there is an engineer-approved match 290 for the competitor product number. If there is an engineer-approved match (the answer is “Yes”), the match is provided to the user at step 330 (for example, via the U/I Module 210). If there is no engineer approved match (the answer is “No”), the execution of decision tree 300 continues at step 340.

Step 340 of decision tree 300 is determining whether there is a community-approved match associated with the competitor product number in the query. Step 340 may include, for example, checking match database 140 to determine if there is a community-approved match 285 for the competitor product number. If there is a community-approved match 285 (i.e., the answer is “Yes”), the match is provided to the user at step 350 (for example, via the U/I Module 210). If there is no community-approved match 285 (the answer is “NO”) the execution of the decision tree continues at step 360.

Step 360 of decision tree 300 is requesting a GAI model generated match. Step 360 may be performed by Prompt Generation Module 225 generating a prompt for the GAI model 150. Step 360 of decision tree 300 corresponds to the generating the prompt in step 407 of method 400, according to some embodiments. Once product matching application 120 receives a GAI model-generated match (as discussed in step 411 of method 400), the GAI model-generated match is provided to the user at step 370.

FIGS. 4A and 4B illustrate a computer-implemented method 400 for competitive product matching performed according to some embodiments.

Step 401 of method 400 is performing initial GAI model training. Step 401 may be performed by GAI Update Module 230. During initial training, parameters of GAI model 150 are adjusted to encode information. Initial training of GAI model 150 is generally performed on a base model. A base model may be licensed and hosted by a third party, purchased, or acquired as an open-source model. The base model may have been pre-trained on a vast amount of data. In general, however, a base model is not specifically trained to perform industrial design functions. The initial training in step 401 fine-tunes GAI model 150 to perform industrial design tasks. The initial training in step 401 may be an unsupervised learning process including providing static data to GAI model 150. The static data provided to GAI model 150 during initial training includes product information such as industrial product specifications, industrial product certifications, industrial product regulations, industrial product catalogs, or any combination thereof.

Step 403 of method 400 is identifying a first product number. In some embodiments, step 403 may further include identifying a first set of product numbers including the first product number. Step 403 may be performed by U/I Module 210 of FIG. 2. In some embodiments identifying the first product number (or firs set of product numbers) includes receiving from a user, via a user interface, a product-matching query including the product number(s) associated with a first manufacturer (e.g., a competitor manufacturer). The product matching query may further include a request to identify a corresponding industrial product manufactured by a second manufacturer (e.g., the owner of the product matching application 120) capable of substitution for respective products identified in the product matching query. A user may submit such a product matching query when the user wants to replace industrial systems or components while maintaining the same functionality. In other embodiments, the identifying the first product number in step 403 may include identifying that a competitor manufacturer has released a new industrial product (such as a new model for a valve), in order to preemptively update match database 140 before a user even submits a query.

Step 405 of method 400 is determining to utilize GAI model 150 to identify an equivalent industrial product. Step 405 may be performed by Prompt Generation Module 225 of FIG. 2. Determining to use GAI model 150 may include determining both: that there are no engineer-approved matches 290 for the first industrial product, and determining that there are no community-approved matches 285 for the first industrial product. Step 405 may be represented by steps 320 and 340 of decision tree 300 of FIG. 3, where the answers at steps 320, 340 are “No.” In embodiments in which previous model-generated matches are stored in match database 140, step 405 may further include determining that there are no pre-existing model-generated matches (e.g., model-generated matches 280 of FIG. 2). The determination to utilize GAI model 150 is thus based on a lack of pre-existing matches in match database 140. In scenarios in which a first set of product numbers was identified in step 403, step 405 may include making a determination to utilize GAI model 150 for a subset of the first set of product numbers. Specifically, while some of the product numbers in the first set may include pre-exiting matches in match database 140 (such that GAI assistance is not required), the subset of the product numbers may not be associated with any pre-existing matches in match database 140. Thus, step 405 may include determining to utilize GAI model 150 for the subset.

Step 407 of method 400 is generating a prompt for GAI model 150. Step 407 may be performed by Prompt Generation Module 225 of FIG. 2. The prompt may be generated using a prompt template, such as prompt template 710 of FIG. 7. The prompt may include the first product number associated with the first manufacturer (e.g., a competitor manufacturer) and a request to respond with a product name of the closest equivalent product (i.e., “match”) made by a second manufacturer (e.g., the owner of product matching application 120). Where there are multiple product matches to be identified (e.g., for the subset determined in step 405) all of the product names in the subset may be included in the same prompt. Alternatively, a separate prompt may be generated for each product name in the subset. The prompt may also include a request to generate a confidence score for each match, where the confidence score is a percentage likelihood that the match generated by GAI model 150 is an acceptable match. The prompt may include instructions to generate the confidence score based on various parameters, including the similarity of specifications, the similarity in functional capabilities, and similarities in compatibility features.

Step 409 of method 400 is submitting the prompt to GAI model 150. Step 409 may be performed by GAI Interface Module 235 of FIG. 2.

Step 411 of method 400 is receiving the second product number from GAI model 150, where the second product number is a model-generated equivalent for the first product number. Step 411 may be performed by GAI Interface Module 235 of FIG. 2. The second product number identifies a product made by the second manufacturer (e.g., the owner of the product matching application 120). Step 411 may further include receiving a second set of product numbers from GAI model 150, where each product number in the second set is provided as a substitution recommendation for a corresponding product number in the subset (i.e., the subset identified in step 405). Step 411 may further include receiving a confidence score for each match, where the confidence score is a percentage likelihood that the product name received from the GAI model (e.g., the product name for the in-house product) is an acceptable substitute for the product name in the user query (e.g., for the competitor product). For example, a confidence score of 90% indicates a 90% likelihood that the second industrial product is an acceptable substitute for the first industrial product. The product matches are determined by GAI model 150 based on learned product information and various considerations provided in the prompt including, for example, similar specifications, similar functional capabilities, similar interoperability features, quality, size, materials, and cost.

Step 413 of method 400 is storing the second product number(s) in association with the first product number(s) in match database 140 as a model-generated match. Step 413 may be performed by the Match Update Module 220. Matches stored in step 413 may further include the confidence scores generated by GAI model 150.

Step 415 of method 400 is providing a notification to the user. Step 415 may be performed by U/I Module 210. An example, notification is shown in user display 600 of FIG. 6. The notification may include the product matches (i.e., the first set of product numbers in association with the second set of product numbers) and the associated confidence score for model-generated matches.

Step 417 of method 400 is receiving user approval of the match. Step 417 may be performed by U/I Module 210. User approval may be indicated, for example, by the user clicking button 640 of FIG. 6. A user may approve the match if the user reviews the product information (diagrams, specifications, etc.) and agrees that it is an acceptable substitute for the competitor industrial product for which the user submitted a product matching query.

Step 419 of method 400 is storing the match in match database 140 as a community-approved match (e.g., community-approved match 285 of FIG. 2). Step 419 may be performed by the Match Update Module 220 of FIG. 2. Step 419 may be performed in response to receiving the user approval in step 417.

Step 421 of method 400 is providing a review request to an engineer (e.g., an engineer accessing admin device 112 of FIG. 1). Step 421 may be performed by U/I Module 210 of FIG. 2. Step 421 may be performed in response to receiving the user approval in step 417.

Step 423 of method 400 is receiving an engineer approval of the match. Step 423 may be performed by U/I Module 210. The engineer may approve the match after a careful analysis of various factors including functional capabilities of both products, compatibility features of both products, size, materials, among other possible considerations.

Step 425 of method 400 is storing the match in match database 140 as an engineer-approved match (e.g., engineer-approved match 290 of FIG. 2). Step 425 may be performed by Match Update Module 220 of FIG. 2.

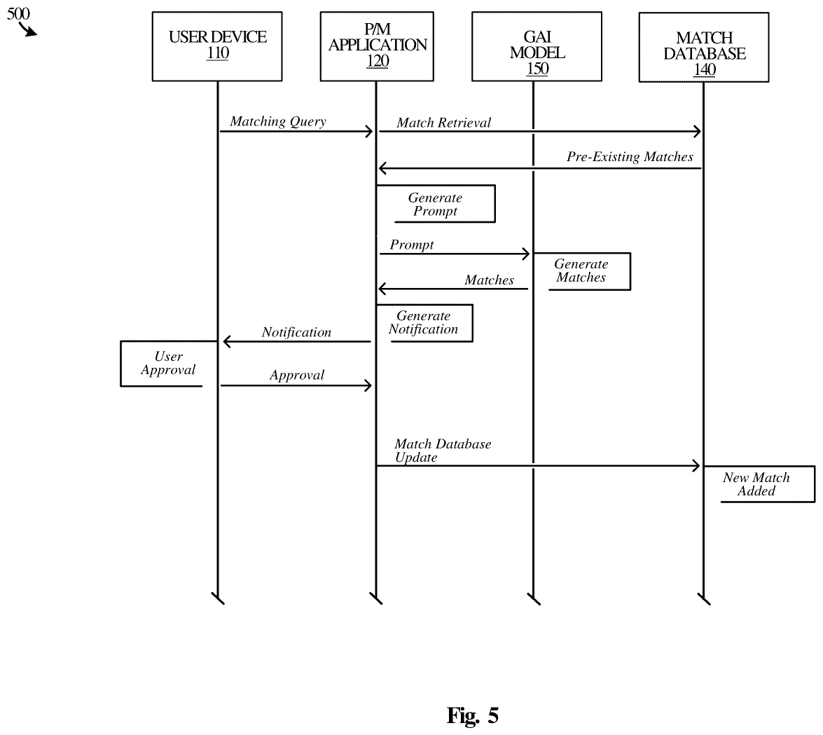

FIG. 5 illustrates operational scenario 500 for competitive product matching performed according to some embodiments. Operational scenario 500 includes user device 110, product matching application 120, GAI model 150, and match database 140.

The operational scenario begins with a user on user device 110 submitting a product matching query to product matching application 120 (e.g., in step 403 of method 400). The matching query may include a list of products numbers associated with a first manufacturer (i.e., a competitor manufacturer), and a request for an identification of the closest equivalent products made by the second manufacturer (i.e., the owner of the product matching application 120). Upon receiving the product match query, the product matching application 120 retrieves existing matches from match database 140. Match database 140 may return pre-existing matches to the product matching application (including, for example, engineer-approved matches 290, community-approved matches 285, and pre-existing model-generated matches 280). A subset of product numbers in the product matching query might not have pre-existing matches in match database 140. The product matching application 120 determines to utilize GAI assistance to determine product matches for the products in the subset, (as discussed in step 405 of method 400). Product matching application 120 generates a prompt (for example, based on prompt template 710 of FIG. 7) including the product names in the subset (i.e., the product names without pre-existing matches), as described in step 407 of method 400. The product matching application 120 submits the prompt to GAI model 150 (as described in step 409 of the method 400). GAI model 150 generates product matches and returns the matches to product matching application 120. Product matching application 120 generates a notification for the user including all matches (i.e., both the pre-existing matches from the match database 140 and the matches newly generated by the GAI model 150). An example notification is shown in the user display 600 of FIG. 6. The notification is provided to the user on the user device 110 (as set forth in step 415 of the method 400). The user may submit an approval of the match, for example, by clicking button 640 of FIG. 6. Product matching application 120, upon receiving the user approval updates match database 140 by adding the new match to the match database 140, for example as community-approved match 285 (see FIG. 2).

FIG. 6 illustrates user display 600, according to some embodiments. The user display 600 may be provided to a user on a user device via U/I Module 210 of FIG. 2. User display 600 may represent a notification sent to the user in step 415 of method 400. User display 600 includes first pane 610 displaying the matching results, and second pane 620 displaying product details. It is noted that in other embodiments, user display 600 may include additional or fewer elements.

First pane 610 includes first list 612 of product numbers for industrial products from a first manufacturer (“Man.-A”) that were included in the user's product matching query (such as the product matching query in step 403 of method 400). First pane 610 further includes second list 614 corresponding to first list 612, where second list 614 represents the results of the product matching performed by product matching application 120. Second list 614 includes product numbers for industrial products from a second manufacturer (“Man.-B”) where the part numbers in second list 614 are recommended matches (substitutes) for corresponding part numbers in first list 612. The product names in second list 614 may be clickable links, allowing the user to view details about selected industrial products in second pane 620. It is noted that in some embodiments, the product names in first list 612 may also be clickable links allowing users to view product details in second pane 620. First pane 610 further includes icons 615 indicating whether each match engineer-approved, community-approved, or model-generated. First pane 610 further includes legend 618 showing the icons associated with each type of match. Finally, first pane 610 may display confidence scores for matches that are model generated. The confidence scores may be received in step 411 of method 400, as discussed above.

Second pane 620 of user display 600 shows information about product names selected by the user in first pane 610. In the example shown in FIG. 6, the user has selected “Man.-B Part #5,” which is a model-generated match recommendation for Man.-A Part #5. Second pane 620 may include image 625 of the part (which in this case, is a pump), clickable button 630 for the user to view specifications, clickable button 635 to reject the match, and clickable button 640 to approve the match (as discussed in step 417 of method 400).

FIG. 7 illustrates prompt template 710 according to some embodiments. Prompt templates 710 may be a file stored in product matching application 120 (for example, in Prompt Generation Module 225). Prompt template 710 may include a combination of text and placeholders, where the placeholders are replaced with the relevant data during prompt generation. It is noted that in some embodiments prompt template 710 may include additional or fewer placeholders. Prompt template 710 may be utilized, for example, by Prompt Generation Module 225 of FIG. 2 to generate prompts for GAI model 150.

Prompt template 710 may include a first placeholder entitled “Manufacturer-A Product Number,” which, during prompt generation is replaced with the product number in the user's product matching query. It is noted that in some embodiments, a list of part numbers from the product matching query is inserted into the first placeholder to request product matches for multiple industrial products in a single prompt. Prompt template 710 may further include a request to respond with a product number for the closest equivalent product made by a second manufacturer, where the name of the second manufacturer may be inserted into the “Manufacturer B” placeholder. Prompt template 710 further includes a request for the model to generate a confidence score, as a percentage likelihood that the recommended part number is an acceptable substitute. Prompt template 710 may include an instruction to search product databases if appropriate. Searching product databases may be appropriate, for example, when GAI model 150 has not been trained on industrial products references in the user's product matching query. Prompt template 710 may further include an instruction to generate the closest equivalent product based on various factors including the similarity of specifications, the capability of performing the same functions, compatibility features including electrical fittings and mounting arrangements, physical dimensions, similar regulatory certifications, and similar costs. It is noted that these various factors are exemplary; prompt template 710 may list various other factors or fewer factors in other embodiments.

FIG. 8 illustrates computing device 801 that is representative of any system or collection of systems in which the various processes, programs, services, and scenarios disclosed herein may be implemented. Examples of computing device 801 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing device 801 may be implemented as a single apparatus, system, or device or may be implemented in a distributed manner as multiple apparatuses, systems, or devices. Computing device 801 includes, but is not limited to, processing system 802, storage system 803, software 805, communication interface system 807, and user interface system 809. Processing system 802 is operatively coupled with storage system 803, communication interface system 807, and user interface system 809.

Processing system 802 loads and executes software 805 from storage system 803. Software 805 includes and implements product matching processes 806, which is (are) representative of the application service processes discussed with respect to the preceding figures, such as method 400 of FIGS. 4A and 4B. When executed by processing system 802, software 805 directs processing system 802 to operate as described herein for at least the various processes, operational scenarios, and sequences discussed in the foregoing implementations. Computing device 801 may optionally include additional devices, features, or functionality not discussed for purposes of brevity.

Referring still to FIG. 8, processing system 802 may comprise a microprocessor and other circuitry that retrieves and executes software 805 from storage system 803. Processing system 802 may be implemented within a single processing device but may also be distributed across multiple processing devices or sub-systems that cooperate in executing program instructions. Examples of processing system 802 include general purpose central processing units, graphical processing units, application specific processors, and logic devices, as well as any other type of processing device, combinations, or variations thereof.

Storage system 803 may comprise any computer-readable storage media device readable by processing system 802 and capable of storing the software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated or transitory signal.

In addition to computer-readable storage media, in some implementations storage system 803 may also include computer readable communication media over which at least some of the software 805 may be communicated internally or externally. Storage system 803 may be implemented as a single storage device but may also be implemented across multiple storage devices or sub-systems co-located or distributed relative to each other. Storage system 803 may comprise additional elements, such as a controller, capable of communicating with processing system 802 or possibly other systems.

Software 805 (including product matching application 120) may be implemented in software instructions and among other functions may, when executed by processing system 802, direct processing system 802 to operate as described with respect to the various operational scenarios, sequences, and processes illustrated herein. For example, software 805 may include program instructions for implementing an application service process as described herein.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for”, but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

The phrases “in some embodiments,” “according to some embodiments,” “in the embodiments shown,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

What is claimed is:

1. A computer-implemented method for competitive product matching, the method comprising:
identifying a first product number of a first industrial product manufactured by a first manufacturer;
determining to utilize a General Artificial Intelligence (GAI) model to identify an equivalent industrial product manufactured by a second manufacturer, wherein the GAI model is trained on industrial product information;
generating a prompt for the GAI model, wherein the prompt comprises:
the first product number, and
a request to provide a second product number of a second industrial product manufactured by the second manufacturer and capable of substitution for the first industrial product;
submitting the prompt to the GAI model;
receiving, from the GAI model in response to the prompt, a response comprising the second product number of the second industrial product manufactured by the second manufacturer;
storing the first product number in association with the second product number in a database and indicating a model-generated match; and
providing to a user, via a user interface, a notification comprising the second product number as the model-generated match for the first product number.

2. The computer-implemented method of claim 1, wherein the determining to utilize the GAI model comprises:
determining that there are no engineer-approved product matches for the first industrial product; and
determining that there are no community-approved matches for the second industrial product.

3. The computer-implemented method of claim 1, wherein the identifying the first product number comprises:
receiving, via the user interface, a query, comprising:
the first product number, and
a request to identify a corresponding industrial product manufactured by the second manufacturer.

4. The computer-implemented method of claim 3, wherein the notification further comprises:
an indication that the second industrial product was generated by the GAI model, and
a user prompt requesting approval to use the second industrial product as an acceptable substitute for the first industrial product; and
wherein the method further comprises:
receiving, from the user, an indication that the second industrial product is an acceptable substitute for the first industrial product; and
in response to receiving the indication from the user, storing the first product number in association with the second product number as a community-approved match.

5. The computer-implemented method of claim 1, further comprising:
providing, to an engineer, a request for approval to use the second industrial product as an acceptable substitute for the first industrial product;
receiving, from the engineer, an indication that the second industrial product is an acceptable substitute for the first industrial product; and
in response to receiving the indication from the engineer, storing the first product number in association with the second product number as an engineer-approved match.

6. The computer-implemented method of claim 1, further comprising:
training the GAI model with the industrial product information comprising one or more of: industrial product specifications, industrial product certifications, industrial product regulations, industrial product catalogs, or a combination thereof.

7. The computer-implemented method of claim 1, wherein:
the first product number is one of a plurality of product numbers for industrial products manufactured by the first manufacturer;
the determining to utilize GAI assistance comprises determining to utilize GAI assistance for a subset of the plurality of product numbers, the subset including the first product number;
the prompt further includes each product number of the subset of product numbers; and
the response from the GAI model further comprises a second plurality of product numbers including the second product number, each of the second plurality of product numbers being provided as substitution recommendations for a corresponding product number from the subset of product numbers.

8. The computer-implemented method of claim 1, wherein:
the prompt further comprises an instruction to search for specifications for the first industrial product from the first manufacturer; and
the request to provide the second product number in the prompt comprises a request to determine the second product number based on the specifications for the first industrial product.

9. The computer-implemented method of claim 1, wherein:
the prompt further comprises a request to generate a confidence score indicating a likelihood that the second industrial product is an acceptable substitute for the first industrial product; and
the response further comprises the confidence score.

10. A system for competitive product matching, the system comprising:
one or more processors; and
one or more memories operably coupled to the one or more processors and having stored thereon software instructions that, upon execution by the one or more processors, cause the one or more processors to:
identify a first product number of a first industrial product manufactured by a first manufacturer;
determine to utilize a General Artificial Intelligence (GAI) model to identify an equivalent industrial product manufactured by a second manufacturer, wherein the GAI model is trained on industrial product information;
generate a prompt for the GAI model, wherein the prompt comprises:
the first product number, and
a request to provide a second product number of a second industrial product manufactured by the second manufacturer and capable of substitution for the first industrial product;
submit the prompt to the GAI model;
receive, from the GAI model in response to the prompt, a response comprising the second product number of the second industrial product manufactured by the second manufacturer;
store the first product number in association with the second product number in a database and indicating a model-generated match; and
provide to a user, via a user interface, a notification comprising the second product number as the model-generated match for the first product number.

11. The system of claim 10, wherein the determining to utilize the GAI model comprises:
determining that there are no engineer-approved product matches for the first industrial product; and
determining that there are no community-approved matches for the second industrial product.

12. The system of claim 10, wherein the identifying the first product number comprises:
receiving, via the user interface, a query, comprising:
the first product number, and
a request to identify a corresponding industrial product manufactured by the second manufacturer.

13. The system of claim 12, wherein the notification provided to the user further comprises:
an indication that the second industrial product was generated by the GAI model, and
a user prompt requesting approval to use the second industrial product as an acceptable substitute for the first industrial product; and
the software instructions comprise further instructions that, upon execution by the one or more processors, cause the one or more processors to:
receive, from the user, an indication that the second industrial product is an acceptable substitute for the first industrial product; and
in response to receiving the indication from the user, store the first product number in association with the second product number as a community-approved match.

14. The system of claim 10, wherein the software instructions comprise further instructions that, upon execution by the one or more processors, cause the one or more processors to:
provide, to an engineer, a request for approval to use the second industrial product as an acceptable substitute for the first industrial product;
receive, from the engineer, an indication that the second industrial product is an acceptable substitute for the first industrial product; and
in response to receiving the indication from the engineer, store the first product number in association with the second product number as an engineer-approved match.

15. The system of claim 10, wherein the software instructions comprise further instructions that, upon execution by the one or more processors, cause the one or more processors to:
train the GAI model with the industrial product information comprising one or more of: industrial product specifications, industrial product certifications, industrial product regulations, industrial product catalogs, or a combination thereof.

16. The system of claim 10, wherein:
the first product number is one of a plurality of product numbers for industrial products manufactured by the first manufacturer;
the determining to utilize GAI assistance comprises determining to utilize GAI assistance for a subset of the plurality of product numbers, the subset including the first product number;
the prompt further includes each product number of the subset of product numbers; and
the response from the GAI model further comprises a second plurality of product numbers including the second product number, each of the second plurality of product numbers being provided as substitution recommendations for a corresponding product number from the subset of product numbers.

17. The system of claim 10, wherein:
the prompt further comprises an instruction to search for specifications for the first industrial product from the first manufacturer; and
the request to provide the second product number in the prompt comprises a request to determine the second product number based on the specifications for the first industrial product.

18. The system of claim 10, wherein:
the prompt further comprises a request to generate a confidence score indicating a likelihood that the second industrial product is an acceptable substitute for the first industrial product; and
the response further comprises the confidence score.

19. A computer-readable storage media device having program instructions stored thereon to perform competitive product matching, wherein the program instructions, upon execution by one or more processors, cause the one or more processors to:
identify a first product number of a first industrial product manufactured by a first manufacturer;
determine to utilize a General Artificial Intelligence (GAI) model to identify an equivalent industrial product manufactured by a second manufacturer, wherein the GAI model is trained on industrial product information;
generate a prompt for the GAI model, wherein the prompt comprises:
the first product number, and
a request to provide a second product number of a second industrial product manufactured by the second manufacturer and capable of substitution for the first industrial product;
submit the prompt to the GAI model;
receive, from the GAI model in response to the prompt, a response comprising the second product number of the second industrial product manufactured by the second manufacturer; and
store the first product number in association with the second product number in a database and indicating a model-generated match; and
provide to a user, via a user interface, a notification comprising the second product number as the model-generated match for the first product number.

20. The computer-readable storage media device of claim 19, wherein the identifying the first product number comprises:
receiving, via the user interface, a query, comprising:
the first product number, and
a request to identify a corresponding industrial product manufactured by the second manufacturer.
